(19) United States
(12) Patent Application Publication
(10) Pub. No.: US 2024/0084806 A1
(43) Pub. Date: Mar. 14, 2024

(54) SIDE CHANNEL COMPRESSOR FOR A FUEL CELL SYSTEM, FUEL CELL SYSTEM, AND USE OF A SIDE CHANNEL COMPRESSOR

(71) Applicant: Robert Bosch GmbH, Stuttgart (DE)

(72) Inventors: Alexander Hero, Lehrensteinsfeld (DE); Armin Merz, Weinstadt (DE)

(21) Appl. No.: 18/263,028

(22) PCT Filed: Dec. 23, 2021
(86) PCT No.: PCT/EP2021/087593

§ 371 Date: Jul. 26, 2023

(30) Foreign Application Priority Data
Feb. 16, 2021 (DE) 10 2021 201 442.9

(51) Int. Cl. F04D 23/00; F04D 25/06; H01M 8/04089; H01M 8/04223

(52) U.S. Cl. CPC F04D 23/008; F04D 25/06; H01M 8/04097; H01M 8/04253; H01M 2250/20

(57) ABSTRACT

The invention relates to a side channel compressor (1) for a fuel cell system (2) for delivering and/or compressing a gaseous medium, in particular hydrogen or a gas containing hydrogen, comprising a housing (3) and an impeller wheel (4) which can be driven by an electric motor and which is accommodated in the housing (3), thus forming at least one side channel (5) disposed axially in relation to the impeller wheel (4), wherein the side channel (5) is connected, via an axial gap (6) remaining between the housing (3) and the impeller wheel (4), to an annular channel (7) which is disposed radially in relation to the impeller wheel (4). According to the invention, the annular channel (7) is connected to an outlet (10) of the side channel compressor (1) via at least one housing bore (8, 9).

The invention also relates to a fuel cell system (2) having a side channel compressor (1) according to the invention, and to the use of a side channel compressor (1) according to the invention as a recirculation fan in a fuel cell system (2).

### BACKGROUND

The invention relates to a side channel compressor for a fuel cell system. In addition, the invention relates to a fuel cell system having a side channel compressor according to the invention, and to a preferred use of a side channel compressor according to the present invention.

Hydrogen-based fuel cells use hydrogen and oxygen for power generation. For example, the energy generated by the fuel cells can be used in order to propel a vehicle. For this purpose, the vehicle is fitted with a fuel cell system comprising a tank for storing hydrogen. The further required oxygen can be drawn from the ambient air.

A fuel cell system typically has a plurality of fuel cells in stacked arrangement, that is to say a fuel cell stack, in order to increase performance. The hydrogen is fed via an anode path to an anode of the stack. In order to lower hydrogen consumption, anode exhaust gas leaked from the stack and still containing unused hydrogen is recirculated via a recirculation path. To ensure a sufficient supply of hydrogen, fresh hydrogen from the tank is mixed with the recirculated anode exhaust gas. The recirculation can be implemented passively, for example with the aid of a suction jet pump, and/or actively with the aid of a recirculation fan disposed in the recirculation path. In particular, a side channel compressor can be used as the recirculation fan.

A side channel compressor includes a rotating impeller wheel for delivering and/or compressing a fluid. Depending on the configuration of the impeller wheel and/or the fluid guide through the side channel compressor, a distinction can be made between a star wheel compressor and a peripheral compressor. In both cases, the fluid to be delivered and/or compressed is fed to a work space via a supply nozzle in which the rotating impeller wheel is accommodated. Via the impeller wheel, the movement energy is transferred to the fluid and converted into pressurized energy so that, in the region of a drain nozzle of the side channel compressor, the pressure is increased compared to the pressure in the inlet nozzle. The impeller wheel is typically driven by an electric motor.

In addition to hydrogen, nitrogen, and water vapor, there is also a liquid water content in the anode gas mixture of a fuel cell system. In order to separate this liquid water fraction, a passive water separator is typically provided upstream of the recirculation fan. This has a filtration efficiency of about 80% to 95% so that a liquid water content remains in the recirculated anode gas. Due to the high centrifugal forces in the side channel compressor, the remaining liquid water fraction is forced into a radial gap surrounding the impeller wheel by an axial gap between the impeller wheel and the housing so that it fills with water. This leads to an increase in the shear friction between the impeller wheel, the water, and the housing, so that sometimes the target speed of the recirculation fan and thus the required amount of recirculation is no longer achieved.

Liquid water collecting in the radial gap between the impeller wheel and the housing of the recirculation fan can also freeze at low outside temperatures, thereby compromising the cold start capability of the fuel cell system.

### SUMMARY

The problem addressed by the present invention is to specify a side channel compressor for a fuel cell system that does not result in or helps to avoid the aforementioned disadvantages.

The side channel compressor is proposed in order to solve this problem. Further, a fuel cell system having a side channel compressor according to the present invention, as well as a preferred use of a side channel compressor according to the present invention, are proposed.

The side channel compressor proposed for a fuel cell system for delivering and/or compressing a gaseous medium, in particular hydrogen or a gas containing hydrogen, comprises a housing and an electromotively driven impeller wheel that is accommodated in the housing while forming at least one side channel disposed axially in relation to the impeller wheel. The side channel is connected, via an axial gap remaining between the housing and the impeller wheel, to an annular channel which is radially disposed in relation to the impeller wheel. According to the invention, the annular channel is connected to an outlet of the side channel compressor via at least one housing bore.

Instead of a radial gap remaining between the impeller wheel and the housing, the proposed side channel compressor comprises a defined annular channel. Thus, with the aid of the annular channel, liquid water displaced radially outward from the at least one side channel during operation of the side channel compressor can be accommodated and discharged via the at least one housing bore to the outlet of the side channel compressor. In this way, the water can be safely removed from the side channel compressor. That is to say, no increased shear friction between the impeller wheel, the water, and the housing is to be feared. The achievement of a desired speed of the side channel compressor is therefore not impacted by the increased shear friction. At the same time, it is ensured that no water remains between the impeller wheel and the housing that freezes at low outside temperatures, thereby endangering cold start capability.

According to a preferred embodiment of the invention, the annular channel has a circumferentially varying flow cross-section. During operation of the side channel compressor, water entering the annular channel can be purposefully supplied to the at least one housing bore and thus to the outlet. The at least one housing bore can thereby take on the function of a water collection point. Preferably, the flow cross-section continuously increases in the direction of rotation of the impeller wheel and decreases abruptly in the region of the at least one housing bore. That is to say, in the rotational direction before the at least one housing bore, the flow cross-section of the annular channel is the largest, and it is the smallest behind the at least one housing bore. This results in a back-pressure building up in the annular channel behind the at least one housing bore, which allows water to be discharged via the at least one housing bore into the outlet itself against a higher pressure level.

The impeller wheel of the proposed side channel compressor is preferably configured so as to be closed on its outer circumferential side. This ensures that a connection of the annular channel to the at least one side channel only exists via the circumferential axial gap. The function of the side channel compressor is thus not impacted by the additional functionality described.

Furthermore, preferably, the at least one housing bore is configured as a blind hole. Accordingly, the flow of water entering the housing bore configured as a blind hole from the annular channel is abruptly decelerated in the blind hole, which leads to the formation of a back-pressure and/or supports the formation of a back-pressure. Alternatively, or in addition, it is proposed that the at least one housing bore is substantially radially or tangentially aligned in relation to the impeller wheel. By substantially radially aligning the housing bore, the water is redirected from the annular channel into the housing bore. The deflection in turn results in the flow in the region of the housing bore being decelerated. A tangential arrangement of the housing bore counteracts a reverse flow of water into the annular channel.

Further, it is proposed that the at least one housing bore is connected to the outlet via a further housing bore having a reduced diameter compared to the first housing bore. This measure also contributes to the formation of a back-pressure. The at least one further housing bore also simplifies the connection of the first housing bore to the outlet of the side channel compressor, so that there is greater design flexibility with regard to the position of the first housing bore.

Advantageously, the at least one housing bore is disposed at the geodetically lowest point of the housing in the use layer. The position of the at least one housing bore thus depends on the respective installation situation of the side channel compressor. The arrangement in the region of the geodetically lowest location ensures that, in the case of an inactive side channel compressor, water enters the at least one housing bore via the annular channel and collects therein. In this way, a freezing of the impeller wheel is avoided at low outside temperatures.

According to a preferred embodiment, side channels disposed on both sides of the impeller wheel are connected to the annular channel via a respective axial gap. Water can thus be removed from two side channels via a single annular channel.

Further preferably, the impeller wheel is connected to a rotor of an electric motor. With the help of the electric motor, the impeller wheel and the rotor are driven in a rotational motion.

Furthermore, because the proposed side channel compressor can be particularly suitable for use in a fuel cell system, a fuel cell system with a side channel compressor according to the invention is proposed. The side channel compressor is disposed in a recirculation path of the fuel cell system for delivering and/or compressing anode exhaust of a fuel cell stack of the fuel cell system. The advantages of the side channel compressor according to the invention also extend to the fuel cell system. In particular, the amount of recirculation required can be provided with the aid of the side channel compressor. In addition, the cold start capability of the fuel cell system can be improved.

Moreover, for the same reasons, the use of a side channel compressor according to the present invention is proposed as a recirculation fan in a fuel cell system.

### BRIEF DESCRIPTION OF THE DRAWINGS

The invention will be explained in more detail in the following with reference to the accompanying drawings. The figures show:

FIG. 1 a schematic longitudinal section through a side channel compressor according to the invention,

FIG. 2 an enlarged section of FIG. 1 in the region of the annular channel,

FIG. 3 a schematic cross-section through the side channel compressor of FIG. 1, and

FIG. 4 a schematic view of a fuel cell system in a vehicle comprising a side channel compressor as the recirculation fan.

### DETAILED DESCRIPTION

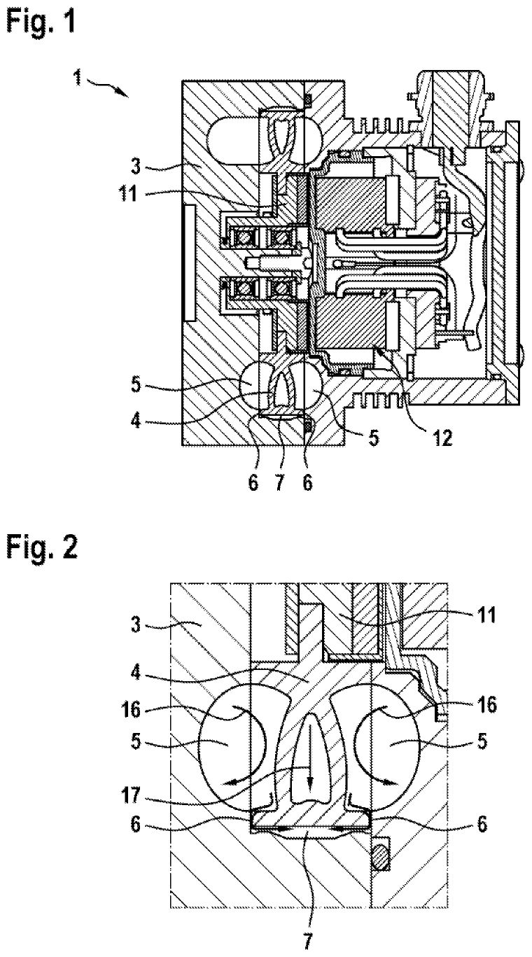

The side channel compressor 1 according to the invention shown in FIG. 1 comprises a housing 3 in which an impeller wheel 4 is accommodated. The impeller wheel 4 is connected to a rotor 11 of an electric motor 12, so that it is driven in a rotational motion. The side channel compressor 1 shown in FIG. 1 can in particular be used as a recirculation fan in a fuel cell system 2 (see FIG. 4).

As can in particular be seen in FIG. 2, the side channel compressor 1 comprises side channels 5 disposed on both sides of the impeller wheel 4 and an annular channel 7 which is disposed radially outward in relation to the impeller wheel 4. When the side channel compressor 1 is used as a recirculation fan in a fuel cell system 2 analogous to FIG. 4, recirculated aqueous anode gas enters the side channels 5. Due to the circulation flow prevailing there (see arrows 16) and due to the centrifugal forces (see arrow 17), the liquid water contained in the anode gas is displaced into the annular channel 7 via axial gaps 6.

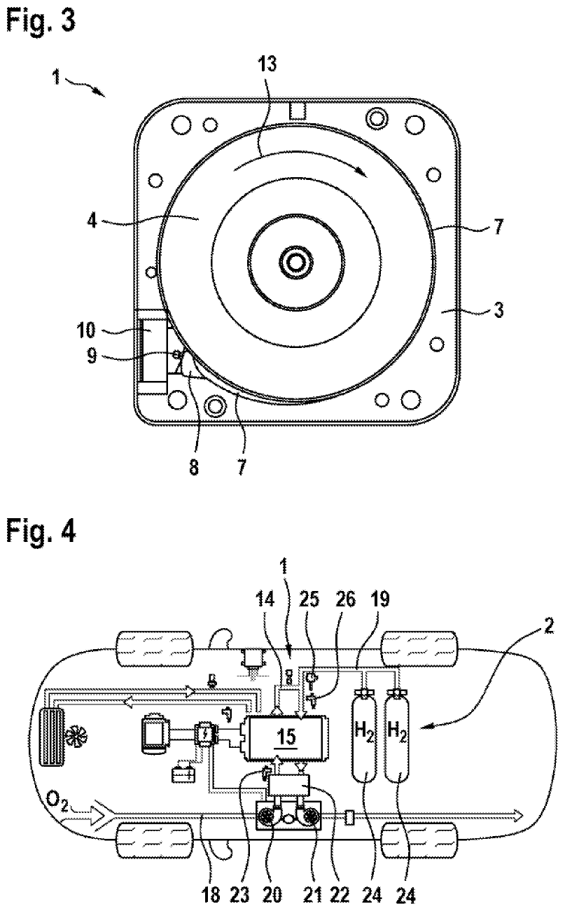

Because the flow cross-section of the annular channel 7 varies in the circumferential direction, and in particular—as shown in FIG. 3—increases continuously towards a housing bore 8 configured as a blind hole in the direction of rotation (see arrow 13) of the impeller wheel 4, the water is supplied to the housing bore 8. Because the flow cross-section of the annular channel 7 is significantly smaller in the direction of rotation behind the housing bore 8 than before the housing bore 8, the water collects in the housing bore 8 and the flow in the annular channel 7 is abruptly decelerated. This builds up a back-pressure that prevents a return flow of water into the annular channel 7. Instead, the water is supplied to an outlet 10 to which the housing bore 8, which is designed as a blind hole, is connected via a further housing bore 9. The back-pressure allows the water to dissipate against an increased pressure level.

Because FIG. 3 shows only the side channel compressor 1 and not the installation situation of the side channel compressor 1, it cannot be seen from this figure that the housing bores 8, 9 and the outlet 10 are preferably disposed in the region of the geodetically lowest location of the side channel compressor 1. In a shutdown event, water in the side channel compressor 1 is thus supplied to the housing bores 8, 9 and the outlet 10 in a gravity-powered manner. Thus, at low outside temperatures, the impeller wheel 4 can be prevented from freezing.

As shown by way of example in FIG. 4, the side channel compressor 1 can be used in particular as a recirculation fan in a fuel cell system 2. The fuel cell system 2 of FIG. 4 serves to generate electrical energy of an electromotively driven vehicle. For this purpose, the fuel cell system 2 comprises a fuel cell stack 15, which is supplied with air as an oxidizer via a cathode path 18 and with hydrogen as a fuel via an anode path 19. The air is drawn from the environment and compressed using a compressor 20 disposed in the cathode path 18. Air exiting the fuel cell stack 15 is supplied to an exhaust turbine 21 for energy recovery. Water contained in the exhaust gas is separated and used in a humidification device 22 in order to humidify the compressed air. In order to cut off the air supply to the fuel cell stack 15 in the shutdown event, a shut-off valve 23 is disposed in the cathode path 18.

To supply hydrogen to the fuel cell stack 15, it is connected to several pressurized gas tanks 24 of a tank system for hydrogen via the anode path 19. Depleted anode gas exiting the fuel cell stack 15 is also recirculated via a recirculation path 14 and mixed with the fresh hydrogen. In the present case, the recirculation is caused both passively with the aid of a jet pump 25 disposed in the anode path 19 as well as actively with the aid of a side channel compressor 1 disposed in the recirculation path 14. In the present case, the latter is configured according to the present invention. To interrupt the hydrogen supply, a further shut-off valve 26 is disposed in the anode path 19.

1. A side channel compressor (1) for a fuel cell system (2) for delivering and/or compressing a gaseous medium, the side channel compressor (1) comprising a housing (3) and an impeller wheel (4) which can be driven by an electric motor and which is accommodated in the housing (3), thus forming at least one side channel (5) disposed axially in relation to the impeller wheel (4), wherein the side channel (5) is connected, via an axial gap (6) remaining between the housing (3) and the impeller wheel (4), to an annular channel (7) which is disposed radially in relation to the impeller wheel (4),
wherein the annular channel (7) is connected to an outlet (10) of the side channel compressor (1) via at least one housing bore (8, 9).

2. The side channel compressor (1) according to claim 1, wherein the annular channel (7) has a flow cross-section that varies in a circumferential direction.

3. The side channel compressor (1) according to claim 1, wherein the impeller wheel (4) is configured to be closed on an outer peripheral side.

4. The side channel compressor (1) according to claim 1,
wherein the at least one housing bore (8) is configured as a blind hole and/or is substantially radially or tangentially aligned in relation to the impeller wheel (4).

5. The side channel compressor (1) according to claim 1,
wherein the at least one housing bore (8) is connected to the outlet (10) via a further housing bore (9) having a reduced diameter compared to the at least one housing bore (8).

6. The side channel compressor (1) according to claim 1,
wherein the at least one housing bore (8, 9) is disposed at a geodetically lowest point of the housing (3) in a use layer.

7. The side channel compressor (1) according to claim 1,
wherein side channels (5) disposed on both sides of the impeller wheel (4) are connected to the annular channel (7) via a respective axial gap (6).

8. The side channel compressor (1) according to claim 1,
wherein the impeller wheel (4) is connected to a rotor (11) of an electric motor (12).

9. A fuel cell system (2) having a side channel compressor (1) according to claim 1, wherein the side channel compressor (1) is disposed in a recirculation path (14) of the fuel cell system (2) for delivering and/or compressing anode exhaust gas of a fuel cell stack (15) of the fuel cell system (2).

10. A use of a side channel compressor (1) according to claim 1 as a recirculation fan in a fuel cell system (2).

11. The side channel compressor (1) according to claim 1, wherein the gaseous medium is hydrogen or a gas containing hydrogen.

12. The side channel compressor (1) according to claim 2, wherein the flow cross-section increases continuously in a rotational direction of the impeller wheel (4) and decreases abruptly in a region of the at least one housing bore (8, 9).
